(19) United States
(12) Patent Application Publication
(10) Pub. No.: US 2016/0125354 A1
(43) Pub. Date: May 5, 2016

(54) METHOD AND SYSTEM FOR MANAGING RESOURCES DISTRIBUTED AMONG RESOURCE WAREHOUSES

(71) Applicant: Alibaba Group Holding Limited, George Town, KY (US)

(72) Inventors: Junwei Kang, Hangzhou (CN); Yueyang Chen, Hangzhou (CN)

(21) Appl. No.: 14/926,338

(22) Filed: Oct. 29, 2015

(30) Foreign Application Priority Data
Oct. 30, 2014 (CN) 201410603704.8

(51) Int. Cl. G06Q 10/08

(52) U.S. Cl. CPC G06Q 10/087

(57) ABSTRACT

Embodiments of the present application relate to a method, apparatus, and system for managing resources. The method includes accessing information pertaining to a first resource warehouse that is a physical warehouse, configuring a second resource warehouse corresponding to the first resource warehouse, the second resource warehouse being a virtual warehouse, adjusting an inventory available for distribution by the second resource warehouse, presenting resources being transferred into the first resource warehouse based at least in part on the adjusted inventory available for distribution of the second resource warehouse, and in the event that resources being transferred and awaiting receipt are transferred into the first resource warehouse, modifying inventory of the first resource warehouse based at least in part on the adjusted inventory available for distribution of the second resource warehouse.

### CROSS REFERENCE TO OTHER APPLICATIONS

This application claims priority to People's Republic of China Patent Application No. 201410603704.8 entitled RESOURCE MANAGEMENT METHOD AND SYSTEM, filed Oct. 30, 2014 which is incorporated herein by reference for all purposes.

### FIELD OF THE INVENTION

The present application relates to resource management of devices. In particular, the present application relates to management of resources in connection with supply chain management.

### BACKGROUND OF THE INVENTION

As the development of e-commerce continues, the demand for transfer of resources between resource warehouses in different geographical areas is increasing. Typically, the distances between resource warehouses are often relatively great, and transportation times between resource warehouses are relatively long. During the period when resources are being shipped, the shipped resources that are in transit are unable to enter the distribution phase. Accordingly, resource inventory turnover periods are relatively longer and cash flows for merchants are slower, thereby resulting in a lack of development of the distribution aspect of the e-commerce business.

According to some related art, two methods of resource distribution solutions are generally used in the management of resources: distribution of goods in stock and presales of future goods. Distribution of goods in stock is unable to reduce inventory turnover periods, and resource distribution opportunities continue to be missed for resources in transit. The method of presales of future goods can reduce the number of inventory turnover days. However, in the event that a supplier's production and/or supply capacity falls behind, such a lag in production and capacity causes overselling and excessive delivery times, thereby diminishing a user's shopping experience.

Accordingly, there is a need to provide a method and system of resource management for shipped resources in transit during the storage and transfer process so that resources in transit can be distributed or circulated in the course of resource management to lower inventory turnover rates and increase the distribution efficiency of e-commerce.

### BRIEF DESCRIPTION OF THE DRAWINGS

Various embodiments of the invention are disclosed in the following detailed description and the accompanying drawings.

FIG. 1 is a flow chart of a method for managing resources according to various embodiments of the present application.

FIG. 2 is a flow chart of a method for managing resources according to various embodiments of the present application.

FIG. 3 is a flow chart of a method for managing resources according to various embodiments of the present application.

FIG. 4 is a flow chart of a method for managing resources according to various embodiments of the present disclosure.

FIG. 5 is a flow chart of a method for managing resources according to various embodiments of the present disclosure.

FIG. 6 is a flow chart of a method for managing resources according to various embodiments of the present disclosure.

FIG. 7 is a functional block diagram of the resource management system according to various embodiments of the present application.

FIG. 8 is a functional diagram of a computer system for managing resources according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In order to make the technical content disclosed herein more detailed and complete, reference may be made to the drawings and the various specific embodiments described below; in the drawings, markings that are the same represent identical or similar components. However, persons with ordinary skill in the art should understand that the embodiments provided in the description below are not intended to limit the scope of coverage of the present application. Additionally, the drawings are merely intended to explain through illustration, and are not drawn according to their original dimensions.

In one typical configuration of the present application, the terminal and server equipment and trusted parties all comprise one or more processors (CPUs), input/output interfaces, network interfaces, and memory. Memory may include such forms as volatile storage devices in computer-readable media, random access memory (RAM), and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, programs, sub-units of programs, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk or other optical storage, magnetic tape cassette, magnetic hard disk storage or other magnetic storage equipment, or any other non-transmission medium that can be used to store information that is accessible by computers. According to the definitions in this document, computer-readable media do not include temporary computer-readable media (transitory media), such as modulated data signals and carrier waves.

The specific implementation methods of the various aspects of the present application are explained in greater detail below in light of the drawings.

Various embodiments relate to a method, system, and apparatus for managing resources in connection with supply chain management. For example, various embodiments for managing resources can be implemented in an e-commerce distribution network.

In the e-commerce distribution network used as an example in the present embodiment, the corresponding e-commerce network system can be defined as follows:

A first resource warehouse (also called the “real warehouse”) corresponds to a resource warehouse that exists as a physical warehouse for storage of resources (e.g., inventory or the like). The first resource warehouse can include the resource management services (e.g., inventory management applications running on computers or the like) provided to suppliers or distributors by an e-commerce platform (e.g., an online trading system such as Taobao, Lynx, Amazon, or the like).

A second resource warehouse (also called the “virtual warehouse”) corresponds to an information system (e.g., computer hardware, operational programs, databases, etc.) set up on a network and used to manage the requisitioning of resources being transferred between first resource warehouses within a certain geographic coverage area. The information system can correspond to a system that manages resources (e.g., goods) in warehouse inventory management. The information system can be a distributed system including application servers, data inventory server applications, or the like.

A resource presentation system corresponds to a network and e-platform system used in e-commerce to share/display detailed resource information. The resource presentation system can comprise computer hardware, operational programs, etc. to provide a user interface for displaying resource information. The detailed resource information can include an image of a corresponding resource, a specification (e.g., of a corresponding resource), user reviews or other evaluations, or the like. The detailed resource information can be displayed on an e-commerce website from which a user can order goods (e.g., resources).

An inventory information system corresponds to a network and/or information management system that is configured to manage the inventory of resources available for distribution.

A resource requisitioning management system corresponds to a management system that manages the resource inventory of resource warehouses and such operations as requisitioning and inward and outward transfers of resources between resource warehouses.

A distribution management system corresponds to a resource distribution management, monitoring, and operating system or platform. The operating system or platform can correspond to a distributed computing system used in connection with providing the e-commerce platform and/or inventory management among warehouses.

A distributed storage system corresponds to a distributed Key/Value storage system configured to store a large volume of data. The data can correspond to an int, a long, a string, an object, or a byte. The data can relate to information associated with an inventory (e.g., a quantity of inventory at a particular warehouse, specifications of a resource included in the inventory, or the like).

A demand management system corresponds to a system that provides service for the customized e-commerce demands of different industries. For example, the demand management system can retrieve information associated with a service corresponding to a warehouse information area, send orders to warehouse operation management services, and accept a warehouse operation in connection with completion of the service.

A resource warehouse management system corresponds to a system that manages interactions between the various systems and data interactions between the first resource warehouse and the second resource warehouse. For example, the resource warehouse management system can correspond to an information system related to warehouse and distribution management information such as release of a warehouse, configuring a scope of services of warehouses and distribution lines.

In some embodiments, a resource can correspond to a good (e.g., a physical object). In some embodiments, the resource can be purchased via an e-commerce website.

In some embodiments, an inventory corresponds to a set of one or more resources. For example, the inventory can refer to a set of resources stored at a resource warehouse. In some embodiments, for some resources at the time of sale, there is a corresponding number of real goods in the warehouse, and for some resources at the time of sale, there is not a corresponding number of real goods in the warehouse, but by setting the second resource inventory goods can be sold in advance, and then shipping can wait until the goods are delivered to the warehouse.

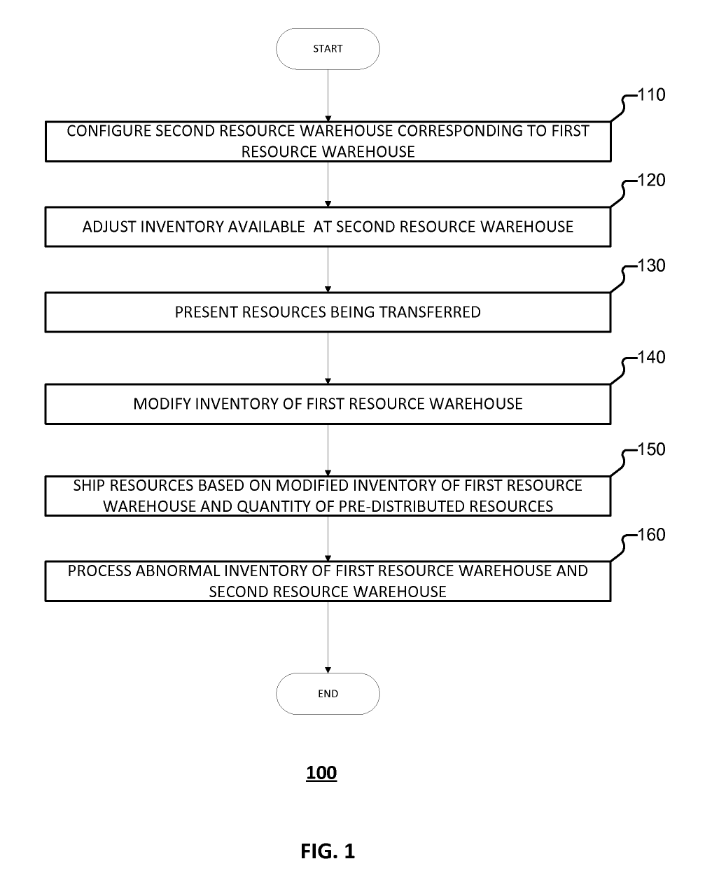

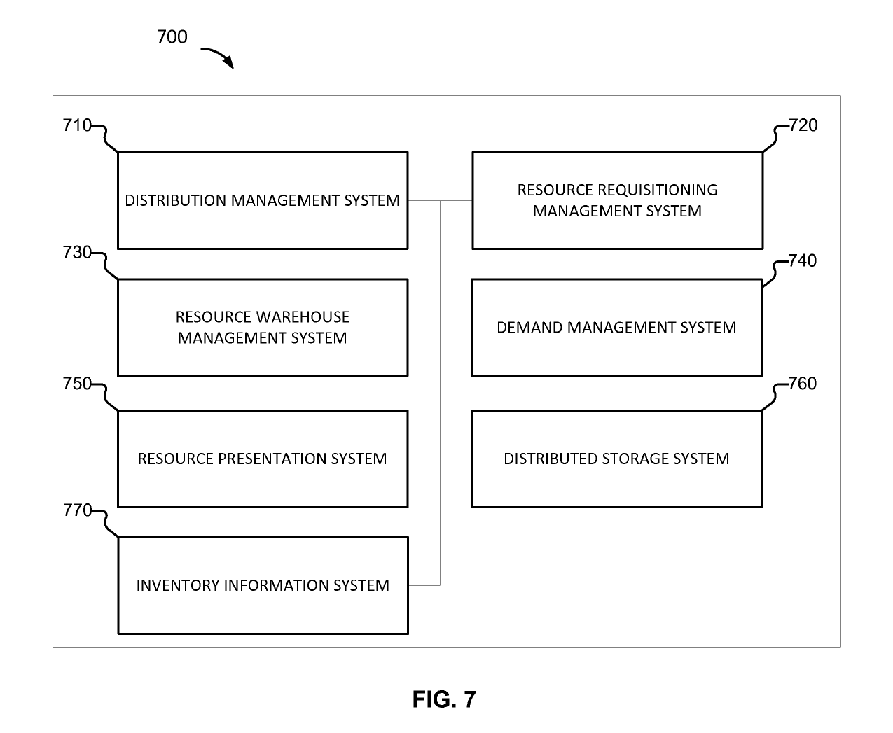

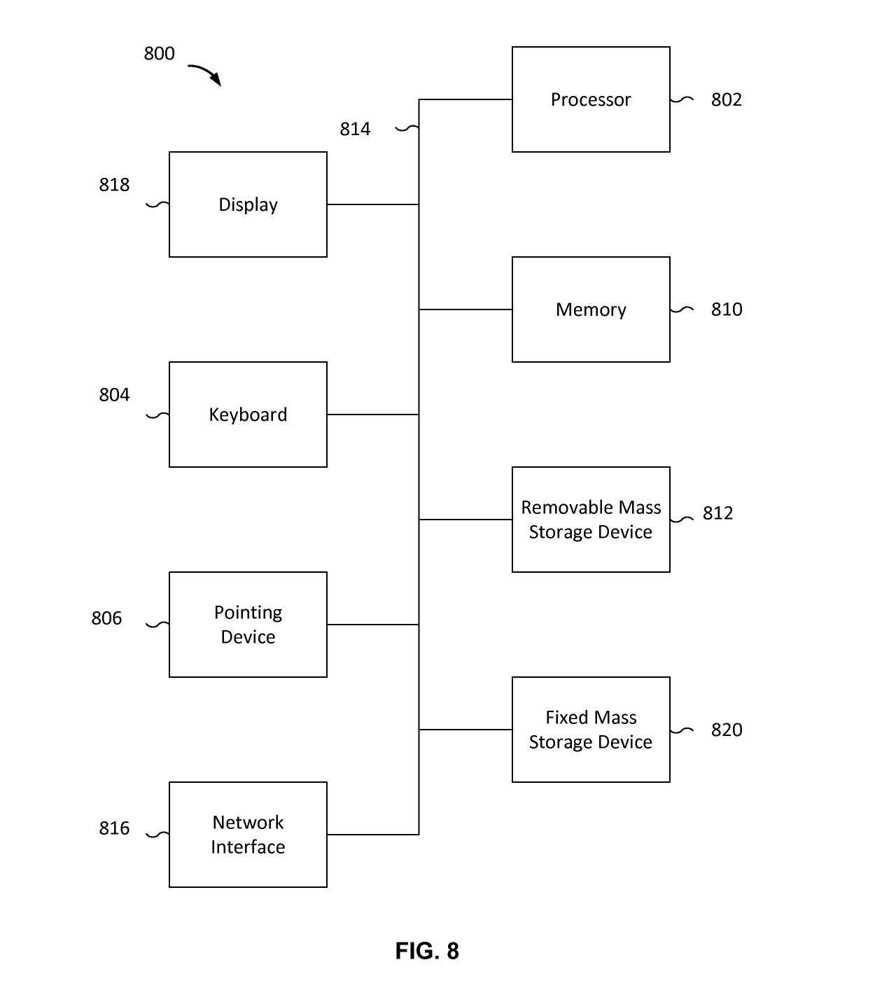

FIG. 1 is a flow chart of a method for managing resources according to various embodiments of the present application. Process 100 can be implemented by system 700 of FIG. 7 or computer system 800 of FIG. 8.

In the present embodiment, for the sake of simplicity of description, the present application is described using the example of an e-commerce distribution network. The second resource warehouse is established according to the requirements of the e-commerce platform, and set up within the distribution management system. According to various other embodiments of the present application, the second resource warehouse can be configured based on the resource requisitioning requirements of the actual storage system, and set up in other systems, platforms, or networks. In some embodiments, the second resource warehouse is configured according to an allocation of resources among one or more physical resource warehouses.

At 110, a second resource warehouse corresponding to a first resource warehouse is configured. For example, the second resource warehouse corresponding to the first resource warehouse can be configured by warehouse staff or an administrator of the e-commerce distribution network. Configuration of the second resource warehouse corresponding to the first resource warehouse can be stored in a database storing configurations of virtual resource warehouses (e.g., second resource warehouses). According to various embodiments, before resources are requisitioned and transferred between resource warehouses (e.g., between the first resource warehouse and the second resource warehouse), or in the course of such requisitioning, a second resource warehouse corresponding to the first resource warehouse is set up and used to manage information associated with the requisitioned resources being transferred. A resource can be requisitioned in connection with placement of an order (e.g., receiving an order via an e-commerce website or the like). According to various embodiments, apart from the type and the resource warehouse identifier of the second resource warehouse being different from the first resource warehouse to which they correspond, all other information is the same as the first resource warehouse, including such information as the address of the resource warehouse, the resource distribution area, the distribution timeliness, supplier relationships, scope of services, delivery routes, scope of services, or the like. The information can be stored in a resource management system. The information can be stored in a database or a key-value cache system. For convenience of explanation, in the text below, the first resource warehouse will be referred to as resource warehouse B, and the second resource warehouse will be defined as resource warehouse B1.

At 120, inventory available at the second resource warehouse is adjusted. Adjustment of the inventory available at the second resource warehouse can comprise adjustment to a value (e.g., in a database or the like) of the inventory associated with the second resource warehouse. Because the second resource warehouse is a virtual warehouse, the adjustment of the inventory available at the second resource warehouse can correspond to merely adjusting the value of the inventory corresponding to the second resource warehouse. The inventory of the corresponding second resource warehouse can be adjusted based on the quantity of resources being transferred that are awaiting to be transferred into the first resource warehouse. The inventory that are awaiting to be transferred into the first resource warehouse can be shipped from another physical resource warehouse, or currently in transit from the other physical resource warehouse to the first resource warehouse. A status of a resource can be changed to a resource being transferred that are awaiting to be transferred in response to receipt of an order (e.g., via an e-commerce website or platform) or some other form of buyer-made request. In some embodiments, at the time that resources being transferred awaiting the first resource warehouse are shipped from a warehouse, the corresponding inventory is locked in (e.g., fixed and not adjusted again) according to the relevant quantity shipped. In some embodiments, a lock or inventory locked in refers to first resource goods to the warehouse that are set aside to ensure there is sufficient resources for inventory that has been sold out for delivery. The locked in inventory is referred to as the lock-in inventory. The inventory of the second resource warehouse corresponding to the first resource warehouse into which resources are to be transferred is adjusted. For example, the inventory of the resources available for distribution at the second resource warehouse is adjusted based on the corresponding lock-in inventory (e.g., the lock-in inventory).

At 130, resources being transferred are presented. The resources can be presented on a user interface of a terminal connected to the resource warehouse management system. In some embodiments, the presentation of the resources being transferred is based on the adjusted inventory available for distribution of the second resource warehouse. In some embodiments, despite the fact that the resources being transferred have not yet actually entered the first resource warehouse into which the resources are to be transferred, based on the resources available for distribution information of the second resource warehouse, the adjusted inventory available for distribution of the second resource warehouse, including the quantity of the resources being transferred, can already be presented to the user through the inventory information system. In some embodiments, the terminal presenting the resources being transferred can retrieve information associated with the inventory available at the second resource warehouse (e.g., the adjusted inventory available at the second resource warehouse) from a database that stores information associated with various resource warehouses, including inventories respectively corresponding thereto.

At 140, the inventory of the first resource warehouse is modified. The inventory of the first resource warehouse can be modified by the inventory information system or the demand management system of the e-commerce distribution network. In some embodiments, when the resources are transferred into the first resource warehouse, the inventory of the first resource warehouse is modified based on the adjusted inventory of resources of the second resource warehouse. In some embodiments, when large volumes of resources need to be allocated and transferred among first resource warehouses, and the resources being transferred are simultaneously in pre-distribution, in order to ensure the continuity of resource distribution, the inventory available for distribution of the first resource warehouse and the second resource warehouse are adjusted and updated in a timely manner, to ensure the accuracy of resources being transferred and the inventory of resources that have actually been transferred into the first resource warehouse. In some embodiments, a database storing information associated with inventory of the first resource warehouse is updated to modify the information associated with the inventory of the first resource warehouse.

At 150, resources are shipped based on the modified inventory of the first resource warehouse and the quantity of pre-distributed resources. In some embodiments, after the resources being transferred are transferred into the first resource warehouse and have been acknowledged as inventory (e.g., after receipt of the inventory is confirmed), based on the quantity of pre-distributed resources (e.g., the quantity of the resources being transferred at 130), resources can be allocated and shipped from the first resource warehouse in a timely manner.

At 160, any abnormal inventory of the first resource warehouse and the second resource warehouse is processed. In some embodiments, when the quantity of resources being transferred decreases or does not match the lock-in inventory, or when the inventory of the first resource warehouse does not match the quantity of resources actually transferred into the first resource warehouse, adjustment processing is then performed with respect to the inventory of the first resource warehouse and the second resource warehouse in order to satisfy timely and accurate updating of the first resource warehouse, and thereby ensure resource distribution and resource warehouse distribution demand. In some embodiments, the database storing information associated with inventory of the first resource warehouse is updated to reconcile a discrepancy between the inventories respectively corresponding to the first resource warehouse and the second resource warehouse.

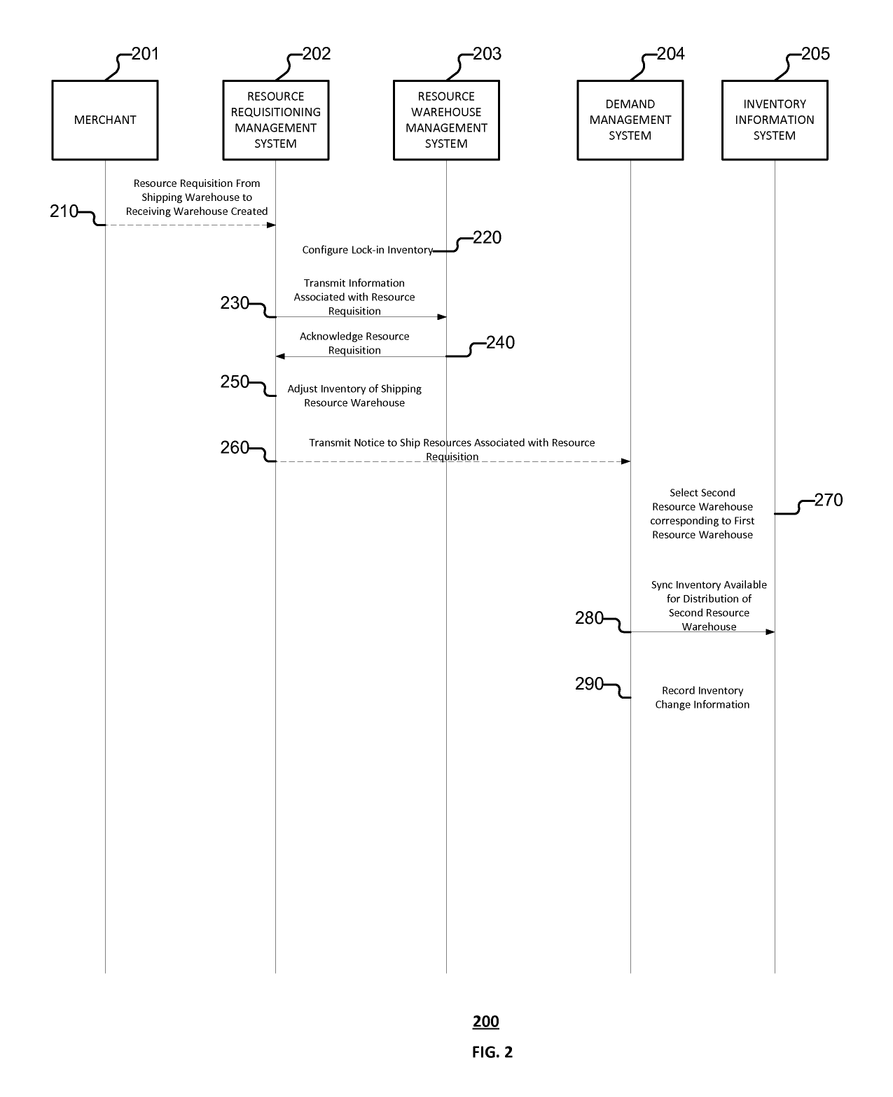

FIG. 2 is a flow chart of a method for managing resources according to various embodiments of the present application. Process 200 can implement 120 of process 100 of FIG. 1. Process 200 can be implemented by system 700 of FIG. 7 and computer system 800 of FIG. 8.

At 210, a goods requisition from a shipping warehouse to a receiving warehouse is created. For example, merchant 201 sends information associated with the resource requisition to resource requisitioning management system 202. Merchant 201 requests the resource requisitioning management system 202 to create a requisition for resources from the shipping resource warehouse to the first resource warehouse. Merchant 201 can send the request for the resource requisitioning management system 202 over a network. For example, merchant 201 can be a client terminal that transmits the information associated with the resource requisition to resource requisitioning management system 202.

At 220, a lock-in inventory is configured based on the resource requisition. Resource requisitioning management system 202 can set up a lock-in inventory based on the quantity of resources to be shipped from the shipping resource warehouse included in the resource requisition transmitted by merchant 201 at 210.

At 230, information associated with the resource requisition is transmitted to resource warehouse management system 203. For example, resource requisitioning management system 202 sends lock-in inventory information and requisition information to resource warehouse management system 203.

At 240, resource warehouse management system 203 acknowledges the resource requisition and returns the acknowledgment to resource requisitioning management system 202. In some embodiments, resource warehouse management system 203 sends an indication of acknowledgement of the resource requisition in response to receiving the information associated with the resource requisition at 230.

At 250, inventory of the shipping resource warehouse is adjusted. For example, resource requisitioning management system 202 decreases the inventory of the shipping resource warehouse. In some embodiments, the inventory of the shipping resource warehouse is adjusted according to the resource requisition. For example, the inventory of the shipping resource warehouse is decreased according to a quantity of resources associated with the resource requisition. In some embodiments, the database storing information associated with inventory corresponding to a resource warehouse (e.g., the shipping resource warehouse) is updated to adjust a value of the inventory of the corresponding resource warehouse.

At 260, demand management system 204 is instructed to ship resources associated with the resource requisition. For example, resource requisitioning management system 202 sends a resource shipping notification corresponding to the requisition to the demand management system 204.

At 270, demand management system 204 selects the second resource warehouse corresponding to the first resource warehouse into which the resources being transferred are to be transferred. In some embodiments, demand management system 204 queries a database storing mappings of second resource warehouses to first resource warehouses to determine the second resource warehouse corresponding to the first resource warehouse to which the resources associated with the resource requisition are to be transferred. For example, demand management system 204 can query inventory information system 205 for an indication of the second resource warehouse corresponding to the first resource warehouse.

At 280, the inventory available for distribution by the second resource warehouse is synchronized. In some embodiments, the quantity of inventory available for distribution of the second resource warehouse is set as equal to the quantity of resources being transferred less an adjustment coefficient. The adjustment coefficient can be determined according to Equation 1 below and rounded up. The adjustment coefficient can be used to prevent situations in which the quantity of resources being transferred is inconsistent with the requisition.

Adjustment coefficient=(quantity of resources being transferred*preset loss prevention ratio) (1)

Referring to Equation 1, the quantity of the resources being transferred corresponds to the quantity of resources associated with the resource requisition created at 210. The preset loss prevention ratio can correspond to a value used to reduce the risk of overselling resources available at a warehouse (e.g., the second resource warehouse). For example, if the resources are not available at the corresponding warehouse, then an order cannot be completed or satisfied. The preset loss prevention ratio can be dependent on an industry associated with the e-commerce platform. The preset loss prevention ratio can be configured, for example, by an administrator. The preset loss prevention ratio can be configured based at least in part on historical information (e.g., historical information relating to inventories, orders, or the like). The preset loss prevention ratio can be configured according to a context of the order, a time at which the order is placed, a context of at least a part of the e-commerce distribution network.

In some embodiments, demand of the inventory available for distribution of the second resource warehouse is synchronized

At 290, information associated with the change in inventory of resources being transferred of the second resource warehouse is recorded. In some embodiments, the database storing information associated with inventory corresponding to the second resource warehouse is updated to adjust a value of the inventory of the second resource warehouse. Demand management system 204 can record the change in inventory of the resources being transferred of the second resource warehouse.

In some embodiments, process 200 is implemented in situations in which the resources being transferred have not yet actually been transferred in, the quantity of the resources being transferred of the second resource warehouse has already been adjusted, and the inventory available for distribution of the resources being transferred of the second resource warehouse has been adjusted.

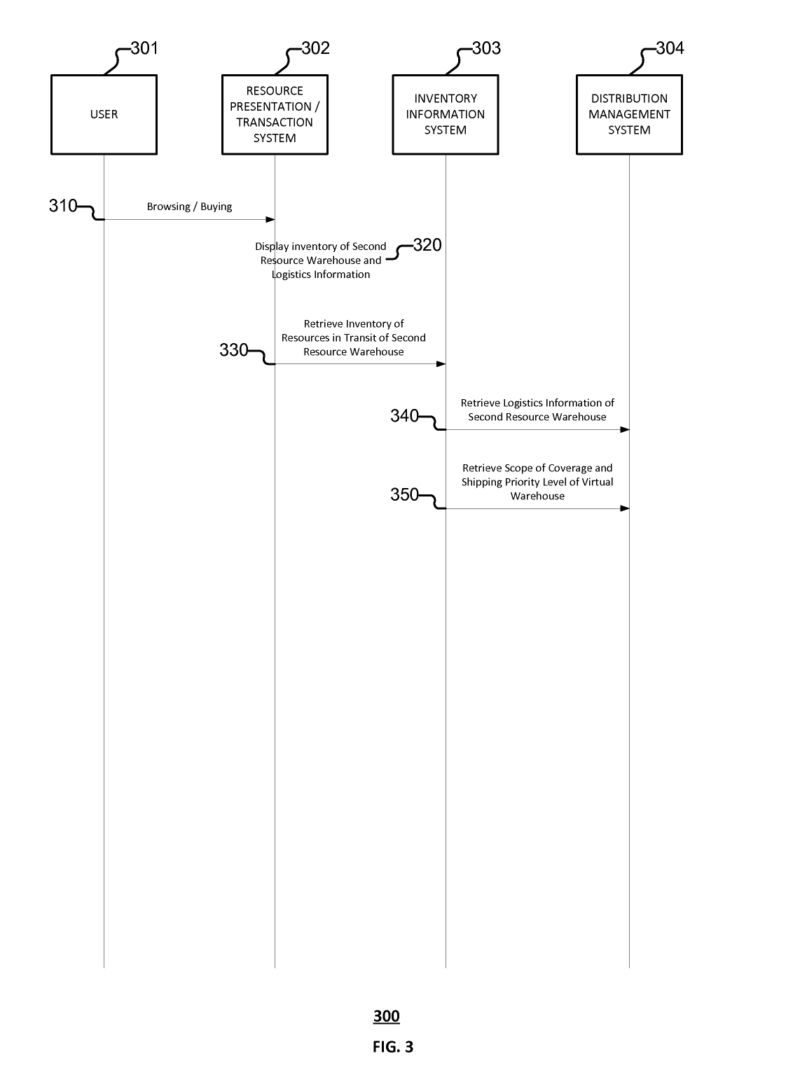

FIG. 3 is a flow chart of a method for managing resources according to various embodiments of the present application. Process 300 can implement 130 of process 100 of FIG. 1. Process 300 can be implemented by system 700 of FIG. 7 and computer system 800 of FIG. 8.

At 310, user 301 can interface with the resource presentation system 302. In some embodiments, user 301 sends a distribution request to the resource presentation system 302. In response to receiving the distribution request, resource presentation system 302 generates awaiting distribution information corresponding to the resources being transferred based on the distribution request. In some embodiments, user 301 corresponds to a consumer of an e-commerce platform. In some embodiments, resource presentation system 302 provides detailed resource information to user 301. User 301 can interface with the resource presentation system 302 over a network such as the Internet. Resource presentation system 302 can provide a user interface to the user 301. User 301 can browse information provided by the resource presentation system 302 using the user interface. In some embodiments, user 301 can generate a purchase request to purchase a resource using information provided by resource presentation system 302.

At 320, resource presentation system 302 provides information associated with an inventory of the second resource warehouse or logistics information. For example, resource presentation system 302 can provide inventory and the distribution timeliness information of the second resource warehouse for the resources being transferred. The distribution timeliness information can include information associated with an expected shipping date, an expected receiving date, a shipping location, a shipping destination, and/or the like. The information associated with the inventory of the second resource warehouse or logistics information can be presented to a user such as a buyer via an e-commerce website (e.g., the e-commerce platform).

At 330, resource presentation system 302 retrieves the inventory of the resources being transferred of the second resource warehouse from inventory information system 303. The presentation system 302 can query a database storing mappings of inventories and second resource warehouses. The database can store information associated with inventories corresponding to resources being transferred to/from second resource warehouses.

At 340, inventory information system 303 retrieves logistics information corresponding to the resources being transferred from distribution management system 304. For example, inventory information system 303 retrieves the distribution timeliness of the resources being transferred from distribution management system 304. In some embodiments, inventory information system 303 retrieves the logistics information at least in part by querying a database storing mappings of inventories to resource warehouses (e.g., second resource warehouses). The database can store logistics information corresponding to resources being transferred to/from resource warehouses.

At 350, inventory information system 303 retrieves the scope of coverage and distribution priority level of the second resource warehouse from distribution management system 304. In some embodiments, inventory information system 303 retrieves the scope of coverage and distribution priority level of the second resource warehouse at least in part by querying a database storing mappings of logistics information to resource warehouses (e.g., second resource warehouses). The database can store scope of coverage and distribution priority levels corresponding to various resource warehouses.

In some embodiments, the e-commerce platform can use the resource presentation system to provide various information about the resources being transferred to the user in real time, in order to facilitate pre-distribution of the resources being transferred.

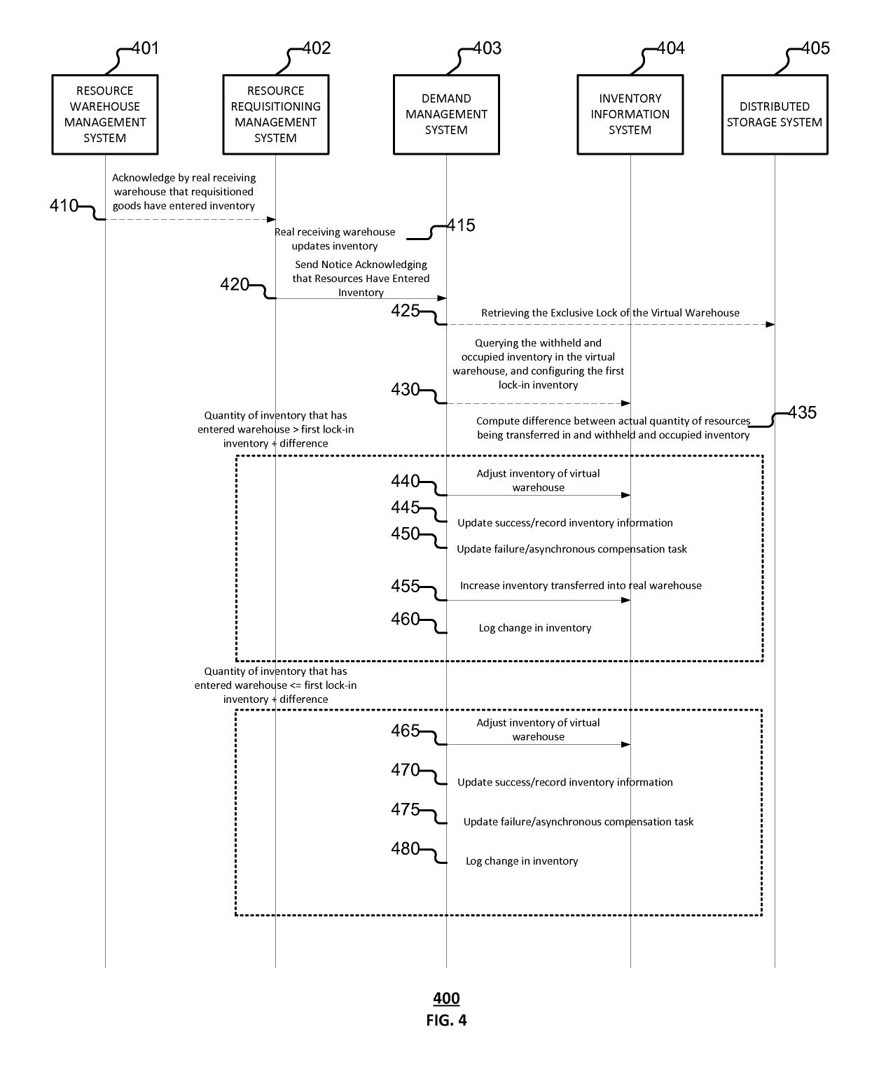

FIG. 4 is a flow chart of a method for managing resources according to various embodiments of the present disclosure. Process 400 can implement 140 of process 100 of FIG. 1. Process 400 can be implemented by system 700 of FIG. 7, and computer system 800 of FIG. 8.

At 410, resource warehouse management system 401 sends to resource requisitioning management system 402 an acknowledgement that the resources being transferred that correspond to the resource requisition have already been transferred into the first resource warehouse. In some embodiments, resource warehouse management system 401 sends the acknowledgement in response to the resources being transferred that correspond to the resource requisition being received at the first resource warehouse. For example, a user at the first resource warehouse can input an indication of receipt of the resources being transferred that correspond to the resource requisition.

At 415, resource requisitioning management system 402 updates the inventory of the first resource warehouse based on the requisition. For example, in response to acknowledgement of the first resource warehouse receiving the resources corresponding to the resource requisition, the inventory of the first resource warehouse is updated. In some embodiments, the inventory of the first resource warehouse is updated contemporaneously with receipt of the resources corresponding to the resource requisition. In some embodiments, updating the inventory of the first resource warehouse includes updating a database storing mappings of inventory to resource warehouses.

At 420, resource requisitioning management system 402 asynchronously transmits inward transfer acknowledgments for resources being transferred that have been transferred in. For example, resource requisitioning management system 402 sends a notice acknowledging that resources corresponding to the resource requisition have been received at the first resource warehouse and/or that the inventory of the first resource warehouse has been updated to reflect receipt of the resources corresponding to the resource requisition. Resource requisition management system 402 can send the acknowledgement to demand management system 403.

At 425, an exclusive lock for an item in the second resource warehouse is retrieved. The exclusive lock can be associated with a resource stock according to an identification of goods, a warehouse identification, an inventory type, and a quantity. The exclusive lock is generally associated with a resource according to product identification, warehouse identification, and/or inventory type. The exclusive lock can correspond to a mechanism that prevents modification of information while being accessed by another entity. For example, if transaction T for a data object A plus X lock, A can only be read and modified in connection with T; any other transaction cannot add A to any type of lock until the release of the lock on A by T. In some embodiments, a format of the exclusive lock can be a symbol (e.g., a logo) in conjunction with a unique identification of the resource or inventory type. In order for the exclusive lock to be effective, the information subject to the exclusive lock cannot be modified at another location the e-commerce distribution network (e.g., inventory data subject to the lock cannot otherwise be modified except in connection with the transaction for which the exclusive lock is retrieved). The second resource warehouse can cause (e.g., instruct) demand management system 403 to send the exclusive lock for the second resource warehouse to the distributed storage system 405. For example, the second resource warehouse can send a message instructing demand management system 403 to send the exclusive lock for the second resource warehouse to distributed storage system 405. In some embodiments, the exclusive lock is defined as resource identifier second resource warehouse code. As an example, the exclusive lock for the second resource warehouse can have the value of key=itemid+“_”+B1 storecode, where B1 storecode corresponds to an identifier of the second resource warehouse, and itemid can correspond to an identifier of a resource. Distributed storage system 405 can store the exclusive lock for the second resource warehouse. For example, distributed storage system 405 can store the exclusive lock in association with an identifier corresponding to the second resource warehouse.

At 430, demand management system 403 queries for the inventory of the resources being transferred, withheld and occupied (e.g., reserved) in the second resource warehouse. For example, demand management system 403 can query a database for an indication of the resources being transferred that are withheld and occupied in the second resource warehouse. In some embodiments, demand management system 403 queries inventory information system 404 for the indication of the resources being transferred that are withheld and occupied in the second resource warehouse. The withheld and occupied inventory can be deemed the lock-in inventory. In some embodiments, the lock-in inventory corresponds to the strategic lock-in inventory, and is a persistence definition. Inventory being withheld can correspond to a status of an inventory subject to creation of a trading order (e.g., in response to receiving an order for a resource, at least a part of the inventory of the resource can be set to a status of withheld); the inventory can be withheld while an order is valid but for which payment has not been received. Inventory being occupied can correspond to a status of an inventory subject to an order for which payment has been received but for which the associated resource(s) have not yet been shipped.

At 435, a difference between the actual quantity of resources being transferred in and the quantity of the withheld and occupied inventory is computed. Inventory information system 404 can compute the difference between the actual quantity of resources being transferred that are transferred in and the quantity of the withheld and occupied inventory. In response to all of the resources being transferred corresponding to the resource requisition being transferred into the first resource warehouse, inward transfer of the resources being transferred is acknowledged. In response to the inward transfer (e.g., receipt) of all the resources being transferred being acknowledged, the difference corresponds to the actual quantity of resources less the withheld and occupied inventory (e.g., difference=actual_quantity−plan_actual_quantity). In the event that the resources being transferred corresponding to the resource requisition are partially transferred into the first resource warehouse (e.g. in the event that less than all of the resources being transferred are received by the first resource warehouse), inward transfer of the resources being transferred is partially acknowledged (e.g., receipt of less than all of the resources being transferred is acknowledged) at this time, and the difference between the actual quantity of the resources being transferred in and the quantity of the withheld and occupied inventory is 0.

In the event that the actual quantity of resources being transferred in (e.g., quantity of received resources) of the resources being transferred is greater than the sum of the lock-in inventory and the difference computed at 435, 440-460 are performed. At 440, demand management system 403 adjusts the resource inventory of the second resource warehouse. In some embodiments, demand management system 403 adjusts the resource inventory of the second resource warehouse by updating a database storing a mapping of inventories to resource warehouses. In some embodiments, adjustment of the inventory of the second resource warehouse corresponds to reducing the inventory of the second resource warehouse. For example, the amount of the reduction is equal to the real quantity of resources transferred in less the sum of the lock-in inventory and the difference computed at 435 (e.g., reduction=quantity of inventory transferred in−lock-in inventory−difference).

In response to the resource inventory of the second resource warehouse being successfully updated, at 445, demand management system 403 records baseline inventory information of the resources transferred in (e.g., the received resources). In some embodiments, the baseline inventory information comprises information such as the quantity of inventory, the time stamp, the requisition number, or the like. The time stamp can correspond to a time at which the corresponding resources were received at the first resource warehouse.

In response to a failure in the update of the resource inventory of the second resource warehouse, at 450, demand management system 403 generates an asynchronous compensation task. In some embodiments, the asynchronous compensation task corresponds to a task for reconciling a discrepancy of the records associated with the inventory of the second resource warehouse.

At 455, in connection with the compensation task of 450, demand management system 403 increases the resource inventory of the first resource warehouse corresponding to the second resource warehouse. In some embodiments, the amount of the increase to the resource inventory of the first resource warehouse is the quantity of inventory transferred into the resource warehouse less the lock-in inventory less the difference computed at 435 (e.g., quantity=quantity of inventory transferred in−lock-in inventory−difference).

At 460, demand management system 403 logs the relevant inventory changes to the first resource warehouse and the second resource warehouse. For example, the demand management system 403 updates records respectively corresponding to the first resource warehouse and the second resource warehouse in a database storing a mapping of inventories to resource warehouses.

In the event that the actual quantity of resources being transferred that are transferred in (e.g., quantity of received resources) is less than or equal to the sum of the lock-in inventory and the difference computed at 435, 465-480 are performed. At 465, demand management system 403 adjusts the resource inventory of the second resource warehouse. In some embodiments, demand management system 403 adjusts the resource inventory of the second resource warehouse by updating a database storing a mapping of inventories to resource warehouses. In some embodiments, adjustment of the inventory of the second resource warehouse corresponds to reducing the inventory of the second resource warehouse. For example, the amount of the second resource warehouse inventory adjustment is equal to the second resource warehouse inventory quantity less the sum of the quantity transferred into inventory and the difference computed at 435 (e.g., adjustment=the lock-in inventory−the quantity transferred into inventory−difference).

In response to the resource inventory of the second resource warehouse being successfully updated, at 470, demand management system 403 records a baseline inventory information of the resources transferred in (e.g., the received resources). In some embodiments, the baseline inventory information comprises information such as the inventory quantity, the time stamp, the requisition number, and/or the like. The time stamp can correspond to a time at which the corresponding resources were received at the first resource warehouse.

In response to a failure in the update of the resource inventory of the second resource warehouse, at 475, demand management system 403 generates an asynchronous compensation task. In some embodiments, the asynchronous compensation task corresponds to a task for reconciling a discrepancy of the records associated with the inventory of the second resource warehouse.

At 480, in connection with the compensation task of 475, demand management system 403 logs (e.g., records) the relevant inventory changes to the first resource warehouse and the second resource warehouse.

In some embodiments, in the event that the resources being transferred are actually transferred into (e.g., received by) the first resource warehouse, the e-commerce platform can promptly modify the inventory of the first resource warehouse based on the adjusted inventory of resources of the second resource warehouse, thereby ensuring the accuracy of the resource inventory available for distribution.

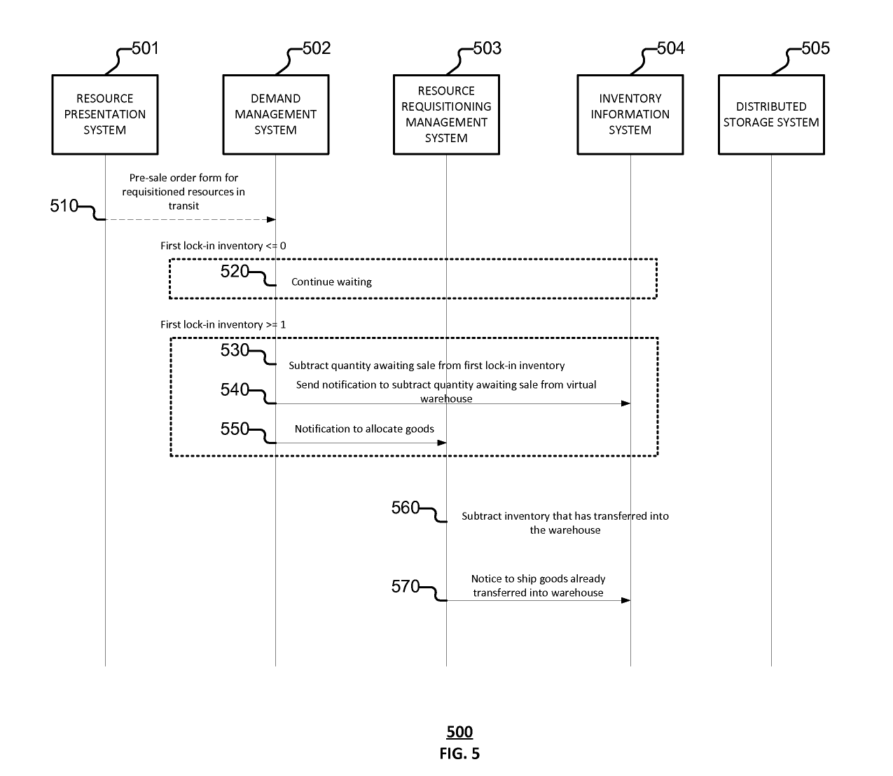

FIG. 5 is a flow chart of a method for managing resources according to various embodiments of the present disclosure. Process 500 can implement 120 of process 100 of FIG. 1. Process 500 can be implemented by system 700 of FIG. 7 and computer system 800 of FIG. 8.

At 510, resource presentation system 501 requests information associated with the resources being transferred (e.g., the resources associated with the resource requisition). For example, resource presentation system 501 requisitions the pre-distribution information of the resources being transferred from demand management system 502. The pre-distribution information can comprise an indication(s) of whether a resource is withheld, occupied, or the like.

In the event that demand management system 502 determines that the lock-in inventory is less than or equal to 0, 520 is performed. At 520, demand management system 502 continues to wait.

Conversely, in the event that demand management system 502 determines that the lock-in inventory is greater than 0, 530-550 is performed. At 530, demand management system 502 computes the lock-in inventory less the quantity of pre-distributed resources. In some embodiments, demand management system 502 polls for an indication that lock-in inventory is greater than zero. The pre-distributed resources can correspond to inventory of the second warehouse that is previously occupied.

At 540, demand management system 502 notifies the inventory information system 504 to subtract the quantity of pre-distributed resources of the second resource warehouse from the lock-in inventory. In response to receiving the notification to subtract the quantity of pre-distributed resources of the second resource warehouse, inventory information system 504 updates a database storing mappings of inventory information to resource warehouses.

At 550, demand management system 502 sends a notice requisitioning pre-distributed resources to resource requisitioning management system 503.

At 560, resource requisitioning management system 503 subtracts the pre-distributed resource inventory of the first resource warehouse. In some embodiments, the pre-distributed source inventory of the first resource warehouse is subtracted from an inventory already occupied at the second resource warehouse.

At 570, resource requisitioning management system 503 sends a distribution request for pre-distributed resources of the first resource warehouse to inventory information system 504. The first resource warehouse ships the resources based on the distribution command of inventory information system 504, thereby completing the distribution of pre-distributed resources. In the event that the inventory information system 504 receives the distribution request, the inventory information 504 can update the corresponding data. For example, inventory information system 504 can send a request for the distributed storage system 505 to update the corresponding database.

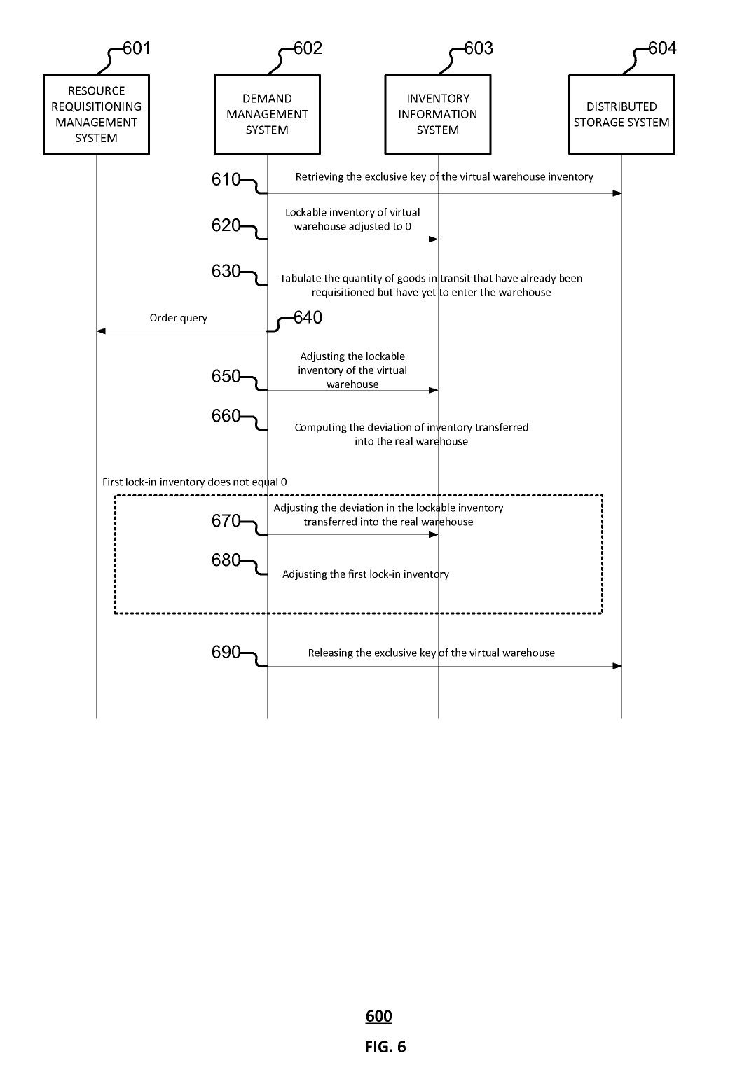

FIG. 6 is a flow chart of a method for managing resources according to various embodiments of the present disclosure. Process 600 can implement 160 of process 100 of FIG. 1. Process 600 can be implemented by system 700 of FIG. 7 and computer system 800 of FIG. 8.

At 610, demand management system 602 retrieves the exclusive lock of the second resource warehouse from distributed storage system 604.

At 620, demand management system 602 notifies inventory information system 603 to adjust the inventory available for sale of the second resource warehouse to 0. In response to receiving the notification to adjust the inventory available for sale of the second resource warehouse, inventory information system 603 adjusts the inventory available for sale of the second resource warehouse.

At 630, demand management system 602 tabulates the quantity of all resources being transferred within a certain period of time that have been requisitioned and are in transit but have yet to actually be transferred into (e.g., received by) the first resource warehouse. The quantity of all resources being transferred within a certain period of time that have been requisitioned and are in transit but have yet to actually be transferred into (e.g., received by) the first resource warehouse can be represented as N-X, where N corresponds to the quantity of all resources being transferred within a certain period of time that have been requisitioned and X corresponds to the quantity of all resources that are in transit but have yet to actually be transferred into the first resource warehouse.

At 640, demand management system 602 queries resource requisitioning management system 601 for the ordered quantity of resources being transferred that have already been pre-distributed. The pre-distributed resources can correspond to inventory of the second warehouse that is previously occupied.

At 650, demand management system 602 sends inventory information system 603 a notification to adjust the inventory of resources available for distribution of the second resource warehouse. In some embodiments, inventory of resources available for distribution corresponds to the quantity N-X tabulated at 630 less the sum of withheld and occupied inventory of the second resource warehouse.

At 660, demand management system 602 computes the inventory deviation of the first resource warehouse. In some embodiments, the deviation of the first resource warehouse is equal to the lock-in inventory (e.g., the strategic lock-in inventory) less the sum of withheld and occupied inventory of the second resource warehouse.

In the event that the lock-in inventory (e.g., the strategic lock-in inventory) is not equal to 0, 670 and 680 are performed. At 670, demand management system 602 adjusts the inventory of resources available for distribution of the first resource warehouse in order to decrease the inventory deviation computed at 660.

At 680, demand management system 602 adjusts the lock-in inventory (e.g., the strategic lock-in inventory). In some embodiments, the lock-in inventory (e.g., the strategic lock-in inventory) adjustment is the lock-in inventory (e.g., strategic lock-in inventory) less the inventory deviation computed at 660. In some embodiments, the adjustment of the lock-in inventory comprises updating a database that stores mappings of information associated with inventories to resource warehouses.

At 690, demand management system 602 releases the exclusive lock of the second resource warehouse to the distributed storage system 604 and completes the processing of abnormal inventory of the first resource warehouse and the second resource warehouse.

In some embodiments, a resource management method solves the issue of the inability to distribute requisitioned resources being transferred among resource warehouses, accurately presenting the resources being transferred or pre-distributing them to the user at the front end, and enabling prompt requisitioning and distribution, thereby increasing the efficiency, scope, and timeliness of e-commerce platform distribution.

FIG. 7 is a functional block diagram of the resource management system according to various embodiments of the present application. Resource management system 700 can implement processes 100-600 of FIGS. 1-6, respectively.

In one typical configuration of the present application, the terminal and server network equipment and trusted parties all comprise one or more processors (CPUs), input/output interfaces, network interfaces, and memory. Memory may include such forms as volatile storage devices in computer-readable media, random access memory (RAM) and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, program sub-units, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical storage, magnetic tape cassette, magnetic hard disk storage or other magnetic storage equipment, or any other non-transmission medium that can be used to store information that is accessible by computers. According to the definitions in this document, computer-readable media do not include temporary computer-readable media (transitory media), such as modulated data signals and carrier waves.

In some embodiments, resource warehouse management system 700 comprises a distribution management system 710, a resource requisitioning management system 720, a resource warehouse management system 730, a demand management system 740, a resource presentation system 750, a distributed storage system 760, and an inventory information system 770. In some embodiments, the distribution management system 710 further comprises the first resource warehouse and the second resource warehouse.

The distribution management system 710 can be implemented as distribution management system 304 in connection with process 300, or the like.

The resource requisitioning management system 720 can be implemented as resource requisitioning management system 202 in connection with process 200, resource requisitioning management system 402 in connection with process 400, resource requisitioning management system 503 in connection with process 500, resource requisitioning management system 601 in connection with process 600, or the like.

The resource warehouse management system 730 can be implemented as resource warehouse management system 203 in connection with process 200, resource warehouse management system 401 in connection with process 400, or the like.

The demand management system 740 can be implemented as demand management system 204 in connection with process 200, demand management system 403 in connection with process 400, demand management system 502 in connection with process 500, demand management system 602 in connection with process 600, or the like.

The resource presentation system 750 can be implemented as resource presentation system 302 in connection with process 300, resource presentation system 501 in connection with process 500, or the like.

The distributed storage system 760 can be implemented as distributed storage system 405 in connection with process 400, distributed storage system 505 in connection with process 500, distributed storage system 604 in connection with process 600, or the like.

The inventory information system 770 can be implemented as inventory information system 205 in connection with process 200, inventory information system 303 in connection with process 300, inventory information system 404 in connection with process 400, inventory information system 504 in connection with process 500, inventory information system 603 in connection with process 600, or the like.

In some embodiments, all of the information of the second resource warehouse in the distribution management system 710 corresponds to the relevant information of the first resource warehouse. Specifically, apart from the type and the resource warehouse identifier of the second resource warehouse being different from the first resource warehouse to which the second resource warehouse corresponds, all other information is the same as the first resource warehouse, including such information as the address of the resource warehouse, the resource distribution area, the distribution timeliness, and supplier relationships.

When resources have been mobilized between first resource warehouses but have yet to enter the warehouse, such resources are referred to as resources being transferred. The inventory information system 770 can be used, based on the instructions of the resource requisitioning management system 720, the resource warehouse management system 730, and the demand management system 740, and based on the quantity of resources being transferred awaiting inward transfer into the first resource warehouse, to adjust the inventory available for distribution of the corresponding second resource warehouse, and to simultaneously transmit corresponding adjusted information to the inventory information system 770.

In some embodiments, for resources being transferred that are awaiting transfer into the first resource warehouse, the corresponding inventory is locked-in based on the relevant quantity shipped at the time that the resources are shipped from the shipping resource warehouse. The locked-in inventory is referred to as the lock-in inventory, and the second resource warehouse of the first resource warehouse awaiting inward shipment of resources adjusts the inventory available for distribution of the resources based on the lock-in inventory. In some embodiments, for the specific explanations of the interaction between the inventory information system 770 and the resource requisitioning management system 720, the resource warehouse management system 730, and the demand management system 740, please refer to the specific explanations of 120 of FIGS. 1 and 210-290 of FIG. 2, which will not be repeated here.

In some embodiments, the resource presentation system 750 further presents the resources being transferred based on the adjusted inventory available for distribution of the second resource warehouse. A user can cause the second resource warehouse included in the distribution management system 710 to send a distribution request to the resource management system 700, and the inventory information system 770 retrieves the scope of distribution coverage and priority level of the second resource warehouse in the distribution management system 710. The resource presentation system 750 retrieves the distribution timeliness of the second resource warehouse from the distribution management system 710, retrieves the inventory of resources awaiting inward transfer of the second resource warehouse from the inventory information system 770, and displays the inventory information of resources being transferred of the second resource warehouse. When the resources being transferred have yet to be actually transferred into the first resource warehouse into which the resources are to be transferred, according to the inventory of resources available for distribution information of the second resource warehouse, the adjusted inventory available for distribution of the second resource warehouse, including the quantity of the resources being transferred, can nevertheless already be presented to the user through the resource presentation system 750. For the specific steps of the interaction between the resource presentation system 750 and the distribution management system 710 and inventory information system 770, please refer to the specific explanations of 130 of FIGS. 1 and 310-350 of FIG. 2, which will not be repeated here.

The demand management system 740 is further used after the resources being transferred are transferred into the first resource warehouse, to modify the inventory information included in the first resource warehouse based on the adjusted inventory of resources of the second resource warehouse. In some embodiments, when large volumes of resources need to be allocated and transferred among first resource warehouses, and the resources being transferred are also in the pre-distribution phase, after the resources enter the first resource warehouse, in order to ensure the continuity of resource distribution, the inventory available for distribution of the first resource warehouse and second resource warehouse is adjusted and updated in a timely manner, to ensure the accuracy of resources being transferred and the inventory of resources that have actually been transferred into the first resource warehouse. For the specific explanations of the interaction between the demand management system 740 and the distributed storage system 760 and inventory information system 770, please refer to the specific explanations of 140 of FIGS. 1 and 410-480 of FIG. 4, which will not be repeated here.

The resource requisitioning management system 720 is further used to ship resources based on the modified first resource warehouse inventory information and the quantity of pre-distributed resources. In some embodiments, the resource requisitioning management system 720 manages the requisitioning of resources for the first resource warehouse, and, based on the distribution information, notifies the resource warehouse management system 730 to arrange for resource distribution from the first resource warehouse. In some embodiments, after the resources being transferred are transferred into the first resource warehouse, based on the quantity of pre-distributed resources returned at 130 of FIG. 1, the first resource warehouse can promptly allocate and transfer resources out of the warehouse. For the specific explanation of the interaction between the resource requisitioning management system 720 and the resource warehouse management system 730, the demand management system 740, the resource presentation system 750, and the inventory information system 770, please refer to the specific explanations of 150 of FIGS. 1 and 510-570 of FIG. 5, which will not be repeated here.

In some embodiments, the demand management system 740 further interacts with the distributed storage system 760 and the inventory information system 770 to process the abnormal inventory information of the first resource warehouse and the second resource warehouse. For the specific explanation of the above-described interaction among systems, please refer to the specific explanations of 160 of FIGS. 1 and 610-690 of FIG. 6, which will not be repeated here.

Thus, using the resource management system in various embodiments solves the issue of inability to distribute requisitioned resources being transferred among resource warehouses, accurately presenting the resources being transferred or pre-distributing the resources to the user at the front end, and enabling prompt requisitioning and distribution, thereby increasing the efficiency, scope, and timeliness of the e-commerce platform distribution.

In some embodiments, the distribution management system 710, the resource requisitioning management system 720, the resource warehouse management system 730, the demand management system 740, the resource presentation system 750, the distributed storage system 760, and the inventory information system 770 are at least partially implemented as modules or sub-modules.

The modules (or sub-modules) described above can be implemented as software components executing on one or more general purpose processors, as hardware such as programmable logic devices and/or Application Specific Integrated Circuits designed to perform certain functions or a combination thereof In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

FIG. 8 is a functional diagram of a computer system for managing resources according to various embodiments of the present application.

Referring to FIG. 8, a computer system 800 for managing resources is displayed. As will be apparent, other computer system architectures and configurations can be used to detect a specified identifier. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818).

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer-readable storage media, described below, depending on whether, for example, data access needs to be bi-directional or uni-directional. For example, processor 802 can also directly and very rapidly retrieve and store frequently needed data in a cache memory (not shown). The memory can be a non-transitory computer-readable storage medium.

A removable mass storage device 812 provides additional data storage capacity for the computer system 800, and is coupled either bi-directionally (read/write) or uni-directionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storage device 812 and fixed mass storage 820 generally store additional programming instructions, data, and the like that typically are not in active use by the processor 802. It will be appreciated that the information retained within mass storage device 812 and fixed mass storage 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

A person skilled in the art should understand that the embodiments of the present application can be provided as methods, systems, or computer software products. Therefore, the present application may take the form of complete hardware embodiments, complete software embodiments, or embodiments that combine software and hardware. Moreover, the present application may take the form of computer program products implemented on one or more computer-operable storage media (including but not limited to magnetic disk storage, CD-ROMs, and optical storage) containing computer-operable program code.

The present application is described with reference to flow charts and/or block diagrams based on methods, devices (systems), and computer program products. Please note that each flow chart and/or block diagram within the flowcharts and/or block diagrams and combinations of flow charts and/or block diagrams within the flowcharts and/or block diagrams can be realized by computer commands. One can provide these computer commands to a general-purpose computer, a specialized computer, an embedded processor, or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer-readable storage devices that can guide computers or other programmable data equipment, with the result that the commands stored on these computer-readable devices give rise to commodities that include command devices. These command devices realize the functions designated in one or more processes in a flow chart and/or one or more blocks in a block diagram.

These computer program commands can also be loaded onto a computer or other programmable data equipment, with the result that a series of operating steps is executed on a computer or other programmable equipment so as to give rise to computer processing. In this way, the commands executed on a computer or other programmable equipment provide steps for implementing the functions designated by one or more processes in a flow chart and/or one or more blocks in a block diagram

In the text above, specific implementation methods of the present application have been described with reference to the drawings. However, persons with ordinary skill in the art are able to understand that it is also possible to make various modifications and substitutions with respect to the specific implementation methods of the present application without departing from the spirit and scope of the present application. These modifications and substitutions all fall within the scope defined in the claims of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
accessing information pertaining to a first resource warehouse that is a physical warehouse;
configuring a second resource warehouse corresponding to the first resource warehouse, the second resource warehouse being a virtual warehouse;
adjusting an inventory available for distribution by the second resource warehouse;
presenting resources being transferred into the first resource warehouse based at least in part on the adjusted inventory available for distribution of the second resource warehouse; and
in the event that resources being transferred are transferred into the first resource warehouse, modifying an inventory of the first resource warehouse based at least in part on the adjusted inventory available for distribution of the second resource warehouse.

2. The method of claim 1, wherein the inventory available for distribution of the second resource warehouse is adjusted based at least in part on a quantity of resources being transferred into the first resource warehouse.

3. The method of claim 1, further comprising:
in response to receiving a distribution request related to the resources being transferred, generating an awaiting distribution message corresponding to the resources being transferred based on the distribution request; and
wherein the modifying of the inventory of the first resource warehouse based on the adjusted inventory available for distribution of the second resource warehouse further comprises:
distributing the corresponding resources being transferred included in the first resource warehouse to a user corresponding to the distribution request based at least in part on the awaiting distribution message.

4. The method of claim 3, further comprising:
processing an abnormal inventory of the first resource warehouse and the second resource warehouse.

5. The method of claim 4, wherein the adjusting of the inventory available for distribution of the second resource warehouse further comprises:
setting up a lock-in inventory based at least in part on a quantity of resources being transferred;
determining the second resource warehouse of the first resource warehouse based at least in part on the first resource warehouse;
synchronizing the inventory available for distribution of the second resource warehouse based on the quantity of resources being transferred; and
storing the synchronized resource inventory of the second resource warehouse.

6. The method of claim 5, wherein the presenting of the resources being transferred based on the adjusted inventory available for distribution of the second resource warehouse further comprises:
retrieving an inventory of resources being transferred of the second resource warehouse;
retrieving logistics information associated with the second resource warehouse; and
presenting the resources being transferred based at least in part on the inventory of resources being transferred and the logistics information of the second resource warehouse.

7. The method of claim 6, wherein the retrieving of the logistics information associated with the second resource warehouse comprises:
retrieving a distribution timeliness of the second resource warehouse; and
retrieving a scope of coverage and a distribution priority level of the second resource warehouse.

8. The method of claim 4, wherein the distributing of the resources based at least in part on the adjusted inventory of the first resource warehouse further comprises:
in the event that the inventory of the first resource warehouse is greater than or equal to a quantity of pre-distributed resources, computing a quantity of the lock-in inventory less the quantity of pre-distributed resources;
subtracting the quantity of pre-distributed resources from an inventory of the second resource warehouse;
issuing a resource recall command based at least in part on the quantity of pre-distributed resources subtracted from the inventory of the second resource warehouse; and
notifying, based at least in part on the resource recall command, the first resource warehouse to subtract a quantity of distributed resources from inventory and to distribute the resources.

9. The method of claim 8, wherein the distributing of the resources based on the adjusted inventory of the first resource warehouse further comprises:
in the event that the lock-in inventory is determined to be less than or equal to 0, entering a waiting state.

10. The method of claim 4, wherein the processing of the abnormal inventory of the first resource warehouse and the second resource warehouse further comprises:
retrieving an exclusive lock of the second resource warehouse;
adjusting the inventory available for distribution by the second resource warehouse to 0;
querying the second resource warehouse for a quantity of resources already pre-distributed;
adjusting the inventory available for distribution by the second resource warehouse;
computing deviation of the inventory of the first resource warehouse;
in the event that the lock-in inventory is not equal to 0, adjusting lockable inventory of the first resource warehouse;
adjusting the lock-in inventory; and
releasing the exclusive lock of the second resource warehouse.

11. The method of claim 1, wherein the modifying of the inventory of the first resource warehouse based at least in part on the adjusted inventory available for distribution by the second resource warehouse further comprises:
confirming that the resources being transferred have been received by the first resource warehouse;
retrieving an exclusive lock of the second resource warehouse;
retrieving an inventory of resources withheld and occupied in the second resource warehouse;
setting a lock-in inventory;
computing a difference calculation with respect to the inventory of the resources withheld and occupied in the second resource warehouse; and
in the event that the inventory of resources withheld and occupied in the second resource warehouse is determined to be greater than a sum of the lock-in inventory and the difference;
adjusting an inventory of the second resource warehouse;
storing the inventory of the second resource warehouse or generating a failure compensation task; and
contemporaneously adjusting the inventory of the first resource warehouse.

12. The method of claim 8, wherein the modifying of the inventory of the first resource warehouse based on the adjusted inventory available for distribution by the second resource warehouse further comprises:
in the event that the inventory of resources withheld and occupied in the second resource warehouse is less than or equal to a sum of the inventory of the first resource warehouse and the difference;
adjusting the inventory of the second resource warehouse; and
recording the inventory of the second resource warehouse or generating a failure compensation task.

13. A resource management system, comprising:
a distribution management system configured to access information pertaining to a first resource warehouse that is a physical warehouse and to configure a corresponding second resource warehouse based on the first resource warehouse, the second resource warehouse being a virtual warehouse;
an inventory information system configured to adjust inventory available for distribution information by the second resource warehouse;
a resource presentation system configured to present resources being transferred into the first resource warehouse based at least in part on the adjusted inventory available for distribution information by the second resource warehouse; and
a demand management system configured to, after the resources being transferred are transferred into the first resource warehouse, modify inventory of the first resource warehouse based at least in part on the adjusted inventory available for distribution information by the second resource warehouse.

14. The resource management system of claim 13, wherein the inventory information system is further configured to adjust the inventory available for distribution by the second resource warehouse based at least in part on a quantity of resources being transferred into the first resource warehouse.

15. The resource management system of claim 13, wherein the inventory information system is further configured to process an abnormal inventory of the first resource warehouse and the second resource warehouse.

16. The resource management system of claim 13, further comprising a resource requisitioning management system configured to set up a lock-in inventory based at least in part on a quantity of resources being transferred, wherein the inventory information system is further configured to determine the second resource warehouse corresponding to the first resource warehouse, the demand management system is further configured to synchronize inventory of resources available for distribution by the second resource warehouse based on the quantity of resources being transferred and to store the synchronized resource inventory of the second resource warehouse.

17. A computer program product, the computer program product being embodied in a non-transitory computer readable storage medium and comprising computer instructions for:
accessing information pertaining to a first resource warehouse that is a physical warehouse;
configuring a second resource warehouse corresponding to the first resource warehouse, the second resource warehouse being a virtual warehouse;
adjusting an inventory available for distribution by the second resource warehouse;
presenting resources being transferred into the first resource warehouse based at least in part on the adjusted inventory available for distribution by the second resource warehouse; and
in the event that resources being transferred are transferred into the first resource warehouse, modifying an inventory of the first resource warehouse based at least in part on the adjusted inventory available for distribution by the second resource warehouse.
